(19) United States
(12) Patent Application Publication
(10) Pub. No.: US 2015/0318822 A1
(43) Pub. Date: Nov. 5, 2015

(54) REDUCING UNEQUAL BIASING IN SOLAR CELL TESTING

(71) Applicants: Xiuwen Tu, San Jose, CA (US); David D. Smith, Campbell, CA (US); David Aitan Soltz, San Jose, CA (US)

(72) Inventors: Xiuwen Tu, San Jose, CA (US); David D. Smith, Campbell, CA (US); David Aitan Soltz, San Jose, CA (US)

(21) Appl. No.: 14/320,475

(22) Filed: Jun. 30, 2014

Related U.S. Application Data
(60) Provisional application No. 61/986,823, filed on Apr. 30, 2014.

(51) Int. Cl. H02S 50/10; H02S 50/15

(52) U.S. Cl. CPC H02S 50/10; H02S 50/15

(57) ABSTRACT

A solar cell testing apparatus can include a first electrical probe configured to receive a first voltage at a first location of a solar cell. The solar cell testing apparatus can also include a second electrical probe configured to receive a second voltage at a second location of the solar cell, where the second location is of the same polarity as the first location.

### CROSS-REFERENCE TO RELATED APPLICATIONS

This application claims the benefit of U.S. Provisional Application No. 61/986,823, filed on Apr. 30, 2014, the entire contents of which are hereby incorporated by reference herein.

### BACKGROUND

Photovoltaic (PV) cells, commonly known as solar cells, are well known devices for conversion of solar radiation into electrical energy. Generally, solar radiation impinging on the surface of and entering into the substrate of a solar cell creates electron and hole pairs in the bulk of the substrate. The electrons and holes migrate to p-doped and n-doped regions in the substrate, thereby creating a voltage differential between the doped regions. The doped regions are connected to the conductive regions on the solar cell to direct an electrical current from the cell to an external circuit. When PV cells are combined in an array such as a PV module, the electrical energy collected from all of the PV cells can be combined in series and parallel arrangements to provide power with a certain voltage and current.

Determining potential defects in solar cells can reduce or even eliminate issues in the final product sold.

### BRIEF DESCRIPTION OF THE DRAWINGS

FIG. 1 illustrates a top-down view of portions of an example solar cell testing apparatus, according to some embodiments.

FIG. 2 illustrates a top-down view of portions of another example solar cell testing apparatus, according to some embodiments.

FIG. 3 illustrates a flow chart representation of a method for testing a solar cell, according to some embodiments.

FIG. 4 illustrates a flow chart representation of another method for testing a solar cell, according to some embodiments.

FIG. 5 illustrates a top-down view of portions of a solar cell testing apparatus, according to some embodiments.

FIG. 6 illustrates a flow chart representation of a method for testing a solar cell, according to some embodiments.

FIG. 7 illustrates a top-down view of a solar cell testing apparatus, according to some embodiments.

FIG. 8 illustrates a top-down view of a feedback circuit, according to some embodiments.

FIG. 9 illustrates a top-down view of a portion of a solar cell testing apparatus, according to some embodiments.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” feedback circuit does not necessarily imply that this feedback circuit is the first feedback circuit in a sequence; instead the term “first” is used to differentiate this feedback circuit from another feedback circuit (e.g., a “second” feedback circuit).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

This specification describes various example solar cell testing apparatuses, followed by various example methods for testing a solar cell. In an example, the testing apparatuses and methods described herein can apply to solar cell testing, such as electro-luminescence testing, photo-luminescence testing, thermal defect testing using a hot spot tester, current-voltage (IV) testing, or a laser-beam induced current testing. Various examples are provided throughout.

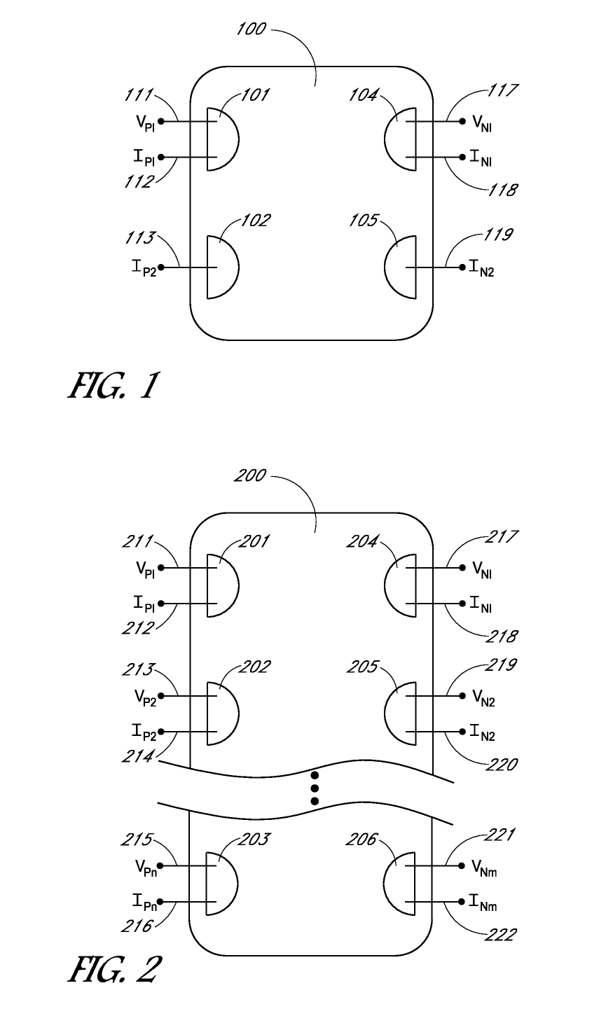

Turning now to FIG. 1, portions of an example solar cell testing apparatus are shown. In one embodiment, the solar cell testing apparatus is configured to test a solar cell 100. The solar cell 100 can be a front contact or a back contact solar cell. Different test methods can be performed such as electro-luminescence testing, photo-luminescence testing, thermal defect testing using a hot spot tester, current-voltage (IV) testing, or a laser-beam induced current testing.

In some embodiments, a solar cell testing apparatus can include a first voltage probe 111 for measuring a first positive voltage V_{P1} and/or a first current probe 112 for measuring a first positive current I_{PP1}. The first voltage probe 111 and first current probe 112 can be placed on or otherwise positioned to couple to a first location 101 of the solar cell 100.

In the illustrated embodiment, the solar cell testing apparatus can include a second current probe 113 for measuring a second positive current I_{P2}. The second current probe 113 can be placed on a second location 102 of the solar cell 100. In an embodiment, the first location 101 and the second location 102 can both be positive contact pads of the solar cell 100.

As shown in the illustrated embodiment, the solar cell testing apparatus can also include a second voltage probe 117 for measuring a first negative voltage V_{N1} and a third current probe 118 for measuring a first negative current I_{N1}. The second voltage probe 117 and third current probe 118 can be placed on a third location 104.

In one embodiment, the solar cell testing apparatus can include a fourth current probe 119 for measuring a second negative current I_{N2}. The fourth current probe 119 can be placed on a fourth location 105 of the solar cell 100. In an embodiment, the third location 104 and the fourth location 105 can both be negative contact pads of the solar cell 100.

Although illustrated as contact pads of solar cell 100, in some embodiments, the first, second, third, and fourth locations 101, 102, 104, and 105 can be any type of location from which an electrical signal can be probed, measured, supplied, or received, including a contact pad, contact finger, or metal contact region (e.g., a region between contact pads), etc.

Although not illustrated, the solar cell testing apparatus can include other components. For example, the solar cell testing apparatus can include an electrical circuit to generate a test current or voltage (e.g., including a digital to analog converter (DAC), an analog to digital converter (ADC), etc.), a camera (e.g., digital camera, near infrared (NIR) camera, thermal imaging camera, etc.) and electrical probes other than those shown in the Figures (e.g., for receiving or applying test signals). In one example, a laser source can also be used to expose a solar cell to a laser, such as in laser-beam induced current measurement.

In an example, portions of the solar cell testing apparatus of FIG. 1 can be used with a Current-Voltage (IV) tester. In IV testing, an electrical load can be applied where current and voltage values are measured relative to the corresponding electrical load values. The current and voltage values can be plotted to generate an I-V curve of the solar cell, from which electrical parameters can be determined. The electrical parameters that can be determined can include the solar cell fill factor (FF) and the energy conversion efficiency (Eff).

The example of FIG. 1 can measure positive and negative voltages at just a single location 111, 117 for each polarity. Measuring voltages at a single location may not accurately provide a complete representation of the actual voltage of the solar cell 100.

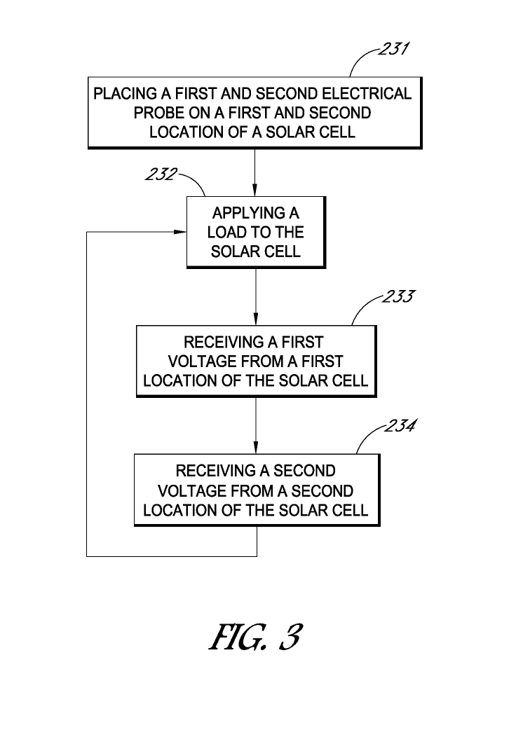

FIG. 2 illustrates portions of an example solar cell testing apparatus, according to some embodiments. In contrast to being limited to measuring the voltage at a single contact location for a given polarity as in the system of FIG. 1, the solar cell testing apparatus of FIG. 2 can measure a voltage at multiple locations of the solar cell for a particular polarity. In an embodiment, the solar cell testing apparatus can include multiple voltage probes. For example, FIG. 2 illustrates a first, second, and up to an N^{th} positive voltage probe 211, 213, 215 where the first, second and N^{th} positive voltage probes 211, 213, 215 can be configured to measure a first, second and N^{th} positive voltage values V_{P1}, V_{P2}, V_{Pn}. The first, second and N^{th} positive voltage probes can be configured to measure voltage at respective contact locations or other locations of the solar cell 200. For example, the first, second and N^{th} positive voltage probes can be placed on or otherwise positioned to couple to a first, second and up to an N^{th} positive contact location 201, 202, 203 of a solar cell 200.

In one embodiment, the solar cell testing apparatus of FIG. 2 can also include a first, second and up to an N^{th} positive current probe 212, 214, 216, where the first, second and N^{th} positive current probes 212, 214, 216 can be configured to measure first, second up to N^{th} positive current values I_{P1}, I_{P2}, I_{Pn}. The first, second and N^{th} positive current probes can be configured to measure current at respective contact locations or other locations of the solar cell 200. For example, the first, second and N^{th} positive current probes can be placed on or otherwise positioned to couple to a first, second and up to an N^{th} positive contact location 201, 202, 203 of a solar cell 200.

As described herein, N can represent any number of probes and corresponding locations of the solar cell 200 (e.g., N=2, 3, 4, 5, etc.). In an embodiment, N can have a value of 2 such that only first and second positive voltage probes and first and second positive current probes exist.

In an embodiment, the solar cell testing apparatus of FIG. 2 can include a first, second and up to a M^{th} negative voltage probe 217, 219, 221, where the first, second and M^{th} negative voltage probes 217, 219, 221 can be used to measure a first, second and M^{th} negative voltage values V_{N1}, V_{N2}, V_{Nm}. In an embodiment, the voltage values V_{N1}, V_{N2}, V_{Nm} can be negative voltage values and the V_{P1}, V_{P2}, V_{Pn} can be positive voltage values. The first, second and M^{th} negative voltage probes can be placed on a first, second and up to an M^{th} negative contact location 204, 205, 206 or other location of the solar cell 200.

The solar cell testing apparatus of FIG. 2 can also include a first, second and up to a M^{th} negative current probe 218, 220, 222, where the first, second and M^{th} negative current probes 218, 220, 222 can be used to measure a first, second and N^{th} negative current I_{N1}, I_{N2}, I_{Nm}. In an embodiment, the current values I_{N1}, I_{N2}, I_{Nm} can be negative current values and the I_{P1}, I_{P2}, I_{Pn}, can be positive current values. The first, second and M^{th} negative current probes can be placed on a first, second and up to a M^{th} negative contact location 204, 205, 206 or other location of the solar cell.

For the above, M can represent any number of probes and corresponding locations of the solar cell 200 (e.g., M=2, 3, 4, 5, etc.). In an embodiment, the locations mentioned above can be any type of location which can be probed, measured, or receive, an electrical signal, including a contact pad, contact finger or metal contact region (e.g., a region between contact pads, etc.). In an embodiment, M can have a value of 2 such that only first and second negative voltage probes and first and second negative current probes exist. In an embodiment, N and M can have the same value.

In an example, portions of the solar cell testing apparatus of FIG. 2 can be used with a Current-Voltage (IV) tester. In IV testing, an electrical load can be applied where current and voltage values are measured relative to the corresponding electrical load values. As described in FIG. 1, the current and voltage values can be plotted to generate the I-V curve of the solar cell, from which electrical parameters (e.g., fill factor (FF), energy conversion efficiency (Eff)) can be determined. The solar cell testing apparatus shown in FIG. 2 can allow for the measurement of voltage and current values at multiple locations of the solar cell. In an example, measuring voltage at multiple locations 201, 202, 203 can provide a more accurate voltage measurement, where the solar cell voltage can be an average of voltage measurements measured from multiple locations, or some other metric indicative of voltage measurements from multiple locations of the same polarity. In another example, significant discrepancies among the voltage values across different measurement locations of a solar cell can indicate problems in the testing apparatus. Also, the testing apparatus of FIG. 2 can allow for the determination of metal contacting issues of the solar cell such as defects caused by process excursions. In an embodiment, a reference solar cell can be used to distinguish between issues of the solar cell testing apparatus to solar cell defects (e.g. metal contact issues). In some embodiments, a reference solar cell can be used for calibration of the solar cell testing apparatus, including the various probes.

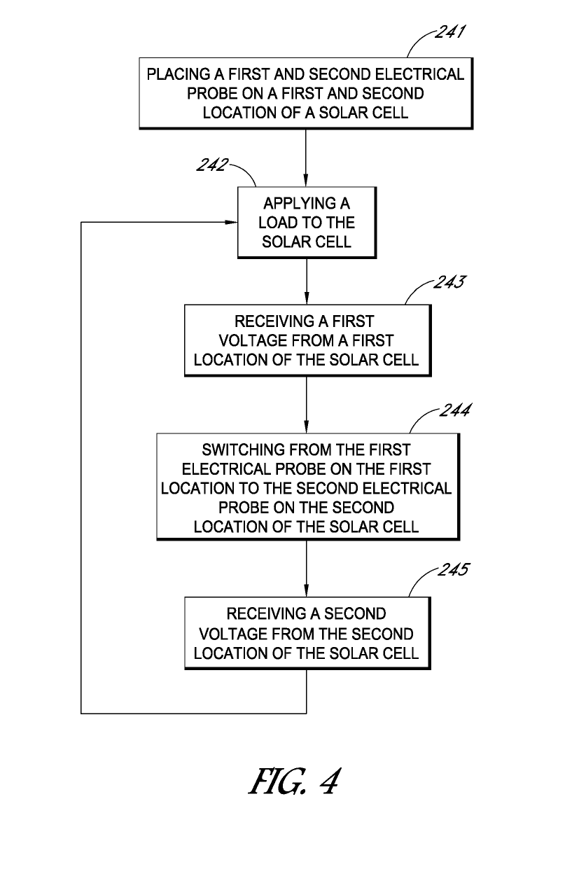

With reference to FIG. 3, a flow chart illustrating a method for testing a solar cell is shown, according to some embodiments.

As shown in 231, first and second electrical probes can be coupled to (e.g., placed on, positioned on, etc.) first and second locations of a solar cell, respectively. In an embodiment, the first and second electrical probes can be first and second voltage probes, respectively. In an embodiment, the first and second locations can be positive or negative contact pads. In some embodiments, the first and second locations are of the same polarity (e.g., both positive). Although FIG. 3 is described in the context of an example having first and second probes and first and second locations, note that additional probes or locations can be used in testing the solar cell.

At 232, a load can be applied to the solar cell. In an embodiment, applying a load to the solar cell can include applying a resistor to the solar cell (e.g., such as performed in Current-Voltage (IV) testing). In an embodiment, applying a load to the solar cell can include applying an electrical load to the solar cell, where the electrical load can be configured to adjust electrical values applied to the solar cell. In an embodiment, applying a load to the solar cell can include applying a signal to the solar cell. In an embodiment, applying a signal to the solar cell can include exposing the solar cell to light (e.g., such as performed in photo-luminescence testing). In an embodiment, applying a signal to the solar cell can include applying a current to the locations, or contact pads, of the solar cell (e.g., such as performed in electro-luminescence testing). In an embodiment, applying a current to the locations can include using the positive and negative current probes of the solar cell testing apparatus (e.g. the positive and/or negative current probes of FIG. 2). In one embodiment, applying a signal to the solar cell can include applying a laser to the solar cell (e.g., such as performed in laser-beam induced current testing).

At 233, a first voltage can be measured from a first location of the solar cell. In an embodiment, a first voltage probe can be used to measure the first voltage. The first location can be a positive or a negative contact location. The first location can also be a contact pad. In an embodiment, the first location can be any type of location from which an electrical signal can be probed, measured, supplied, or received, including a contact pad, contact finger, or metal contact region, etc.

At 234, a second voltage can be measured from a second location of the solar cell. In an embodiment, a second voltage probe can be used to measure the second voltage. The second location can be a positive or a negative contact location. The second location can also be a contact pad. In an embodiment, the second location can be any type of location from which an electrical signal can be probed, measured, supplied, or received, including a contact pad, contact finger, or metal contact region, etc.

In an embodiment, steps 233 and 234 can be performed simultaneously (e.g., at least overlapping in time) or separately. In an example, the first and second voltage measurements can be received 1-100 microseconds apart.

In various embodiments, the method of FIG. 3 can include additional (or fewer) blocks than illustrated. For example, the method of FIG. 3 can further include measuring an N^{th} voltage from an N^{th} location of the solar cell. In an embodiment, an N^{th} voltage probe can be configured to measure the N^{th} voltage. The N^{th} location can be a positive or a negative contact location. The N^{th} location can also be a contact pad. In an embodiment, the N^{th} location can be any type of location from which an electrical signal can be probed, measured, supplied, or received, including a contact pad, contact finger, or metal contact region, etc. N can represent any number of probes and corresponding locations of the solar cell 200 (e.g., N=2, 3, 4, 5, etc.).

In an embodiment, the applied load from step 232 can be changed or varied after performing steps 233 and 234 and the steps 232-234 can be repeated one or more times, such as performed in Current-Voltage (IV) testing.

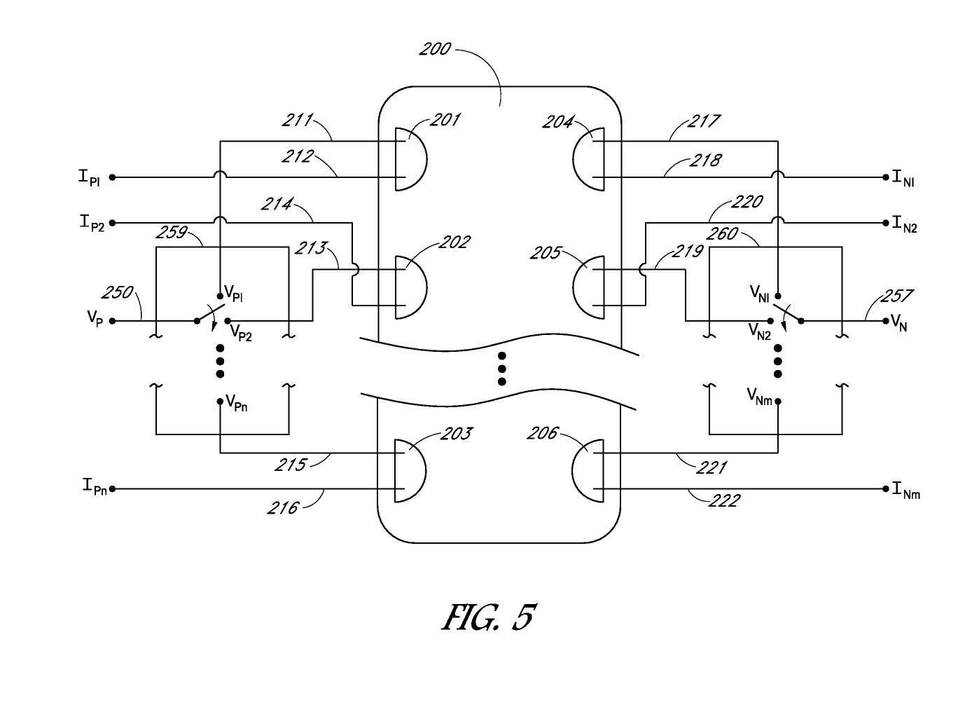

FIG. 4 illustrates a flow chart for another method for testing a solar cell, according to some embodiments.

As shown in 241, a first and second electrical probe can be placed on or otherwise coupled to first and second locations of a solar cell. In an embodiment, the first and second electrical probes can be first and second voltage probes, respectively. In an embodiment, the first and second locations can be positive or negative contact pads. In some embodiments, the first and second locations are of the same polarity (e.g., both positive). As described herein, in various embodiments, additional probes and/or test locations can be used other than the first and second electrical probes and first and second locations.

At 242, a load can be applied to the solar cell. In an embodiment, applying a load to the solar cell can include applying a resistor to the solar cell (e.g., such as performed in Current-Voltage (IV) testing). In an embodiment, applying a load to the solar cell can include applying an electrical load to the solar cell, where the electrical load can be configured to adjust electrical values applied to the solar cell. In an embodiment, applying a load to the solar cell can include applying a signal to the solar cell. In an embodiment, applying a signal to the solar cell can include exposing the solar cell to light (e.g., such as performed in photo-luminescence testing). In an embodiment, applying a signal to the solar cell can include applying a current to the locations, or contact pads, of the solar cell (e.g., such as performed in electro-luminescence testing). In an embodiment, applying a signal to the solar cell can include applying a laser to the solar cell (e.g., such as performed in laser-beam induced current testing).

At 243, a first voltage can be received from a first location of the solar cell. The first electrical probe can be a first voltage probe. The first location can be a positive or a negative contact location. The first location can also be a contact pad. In an embodiment, the first location can be any type of location from which an electrical signal can be probed, measured, supplied, or received, including a contact pad, contact finger, or metal contact region, etc.

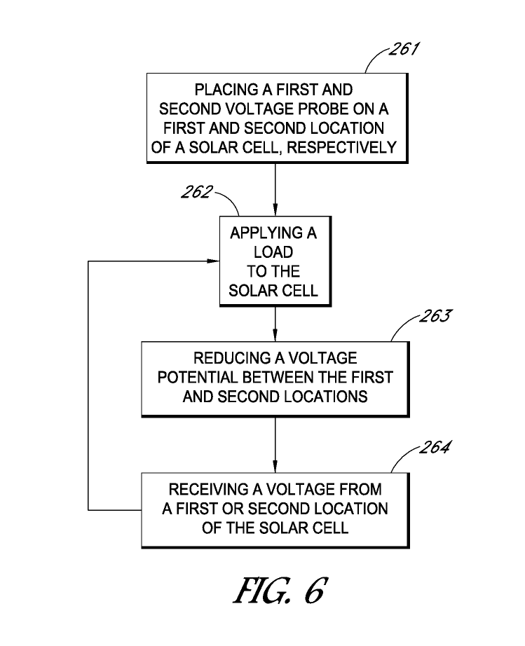

At 244, a switch can be used to switch from the first electrical probe on the first location to the second electrical probe on the second location of the solar cell. In various embodiments, an electrical or mechanical switch can be used to switch from the first electrical probe to the second electrical probe. In an embodiment, multiple switches can be used either alone (e.g., separately switched) or in combination (e.g., switched together), as is shown in the example of FIG. 5. In an example, the electrical switch can be programmed to cycle, allowing for the measurement of voltage values at different locations periodically. Accordingly, note that block 244 may not be performed for each solar cell that is being tested. For example, for some cells, measurements may be taken at multiple locations for a particular polarity whereas for other cells, a measurement may be taken at a single location per polarity or another for a given cell. In one example, the mechanical switch can be manually actuated.

At 245, a second voltage can be received from a second location of the solar cell. In an embodiment, the second electrical probe can be used to measure a second voltage. The second electrical probe can be a second voltage probe. The second location can be a positive or a negative contact location. The second location can also be a contact pad. In an embodiment, the second location can be any type of location which an electrical signal can be probed, measured, supplied, or received, including a contact pad, contact finger, or metal contact region, etc.

In an embodiment, the applied load from step 242 can be changed or varied after performing steps 243-245 and the steps 242-245 can be repeated one or more times.

In various embodiments, the method of FIG. 4 can include additional (or fewer) blocks than illustrated. For example, the method of FIG. 4 can further include switching to an N^{th} electrical probe from an N^{th} location of the solar cell. In an embodiment, an N^{th} electrical probe can be used to measure an N^{th} voltage. The N^{th} location can be a positive or a negative contact location. The N^{th} location can also be a contact pad. In an embodiment, the N^{th} location can be any type of location from which an electrical signal can be probed, measured, supplied, or received, including a contact pad, contact finger, or metal contact region, etc. In an embodiment, N can represent any number of probes and corresponding locations of the solar cell 200 (e.g., N=2, 3, 4, 5, etc.). In an embodiment, switching from a first, second and N^{th} electrical probe can also include monitoring a voltage value at each location of the solar cell. Further note that the example method of FIG. 4 can be used in conjunction with the method of FIG. 3, in some embodiments.

It can be beneficial to measure voltage values at varied locations of a solar cell to validate voltage values at different locations, increase the accuracy of the overall measurement, and to indicate issues with a solar cell or a solar cell testing apparatus. In an example, discrepancies in the measured voltage values between multiple locations of the solar cell can indicate issues with metal contacting for the solar cell or the contact between a voltage probe and a location of the solar cell. In another example, the average value of the measured voltages across multiple locations can be computed, to provide a more accurate measurement (e.g., as compared to voltage measurements taken from a single location). Also, switching can be performed periodically, e.g., not switching during every test cycle used during a full manufacturing or a test process. In an embodiment, the switching can be performed to validate measured voltage values of a testing process.

Turning to FIG. 5, a portion of a solar cell testing apparatus is shown, according to some embodiments. The solar cell testing apparatus can include a first, second and up to an N^{th} positive voltage probe 211, 213, 215.

The solar cell testing apparatus can also include a first, second and up to an N^{th} positive current probe 212, 214, 216. The first, second and up to an N^{th} positive voltage probes and the first, second and up to an N^{th} positive current probes can be coupled to a first, second and up to an N^{th} positive contact location 201, 202, 203 of a solar cell 200. In an embodiment, during operation, a voltage V_{P} can be received from a contact line 250, where a first switch 259 is configured to switch between the first, second and up to an N^{th} positive voltage probes 211, 213, 215. In an embodiment, the first switch 259 can be a mechanical or electrical switch. In an embodiment, switching between the first, second and up to an N^{th} positive voltage probe can allow flexibility as to which voltage (e.g., V_{P1}, V_{P2}, . . . , V_{Pn}) is received at the contact line 250. In an embodiment, the first, second and N^{th} voltages V_{P1}, V_{P2}, . . . , V_{Pn} can be positive voltages. In an embodiment, a first, second and up to an N^{th} current probe 212, 214, 216 can be configured to receive a first, second and N^{th} current I_{P1}, I_{P2}, I_{Pn}. In an embodiment, the first, second and N^{th} currents I_{P1}, I_{P2}, I_{Pn} can be positive currents. In an embodiment, the first, second and N^{th} locations 201, 202, 203 can be of the same polarity. N can represent any number of probes and corresponding locations of the solar cell 200 (e.g., N=2, 3, 4, 5, etc.).

The solar cell testing apparatus can include a first, second, and up to a M^{th} negative voltage probe 217, 219, 221 placed on a first, second and up to a M^{th} negative contact location 204, 205, 206 respectively. The solar cell testing apparatus can also include a first, second and up to a M^{th} negative current probe 218, 220, 222 placed on a first, second and up to a M^{th} negative contact location 204, 205, 206. In an embodiment, a voltage V_{N} can be received from a contact line 257, where a second switch 260 is used to switch between the first, second and up to a M^{th} negative voltage probe 217, 219, 221. In an embodiment, switching between the first, second and up to a M^{th} negative voltage probe 217, 219, 221 can allow receiving a first, second and up to a M^{th} voltage V_{N1}, V_{N2}, V_{Nm} at the contact line 257. In an embodiment, the first, second, and M^{th} voltages V_{N1}, V_{N2}, V_{Nm} can be negative voltages. In an embodiment, the first, second and up to a M^{th} currents I_{N1}, I_{N2}, I_{Nm} can be negative currents. In an embodiment, the first, second and M^{th} negative contact locations 204, 205, 206 can be of the same polarity. M can represent any number of probes and corresponding locations of the solar cell 200 (e.g., M=2, 3, 4, 5, etc.). In an embodiment, M can have the same value as N.

In an embodiment, the portion of a solar cell testing apparatus of FIG. 5 can be used with an electro-luminescence tester, photo-luminescence tester, hot spot tester, Current-Voltage (IV) tester, or a laser-beam induced current tester.

In an embodiment, multiple configurations can exist. In an embodiment, only the first switch 259 can be used (e.g., without the second switch 260). In an embodiment, only the second switch 260 can be used (e.g., without the first switch 259). In another embodiment, multiple switches can be coupled to locations of a same polarity (e.g., for a four positive contact pad arrangement, two switches can be used, one for two of the positive contact pad locations, and the other switch for the other two positive contact pad locations). In another embodiment, a switch can be configured to output measurements of multiple voltages at the same time (e.g., output both V_{P1} and V_{P2} at the same time, whether through separate switches or through separate switching components of first switch 259). Although switches are only shown for voltage probes in the example of FIG. 5, switches can also be used for current probes in some embodiments.

As was the case with the testing apparatus of FIG. 2, the testing apparatus of FIG. 5 can allow for the determination of metal contacting issues of the solar cell such as defects caused by process excursions. In an embodiment, a reference solar cell can be used to distinguish between issues of the solar cell testing apparatus to solar cell defects (e.g. metal contact issues). In some embodiments, a reference solar cell can be used for calibration of the solar cell testing apparatus.

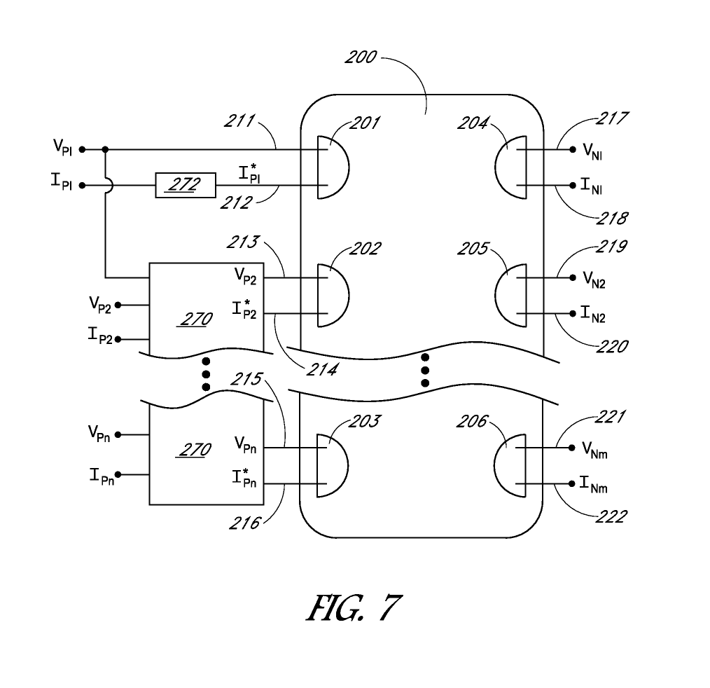

With reference to FIG. 6, a flow chart for a method for testing a solar cell is shown, according to some embodiments.

As shown in 261, first and second electrical probes can be coupled to (e.g., placed on or otherwise positioned) first and second locations of a solar cell, respectively. In an embodiment, the first and second electrical probes can be first and second voltage probes. In some embodiments, the first and second electrical probes can be positive voltage probes or negative voltage probes. In an embodiment, the first and second locations can be positive or negative contact pads. In some embodiments, the first and second locations are of the same polarity. Any number of voltage probes, current probes and locations can be used in testing the solar cell

At 262, a load can be applied to the solar cell. In an embodiment, applying a load to the solar cell can include applying a first, second and up to an N^{th} resistor in parallel to the solar cell (e.g., such as performed in Current-Voltage (IV) testing), where N can be a positive integer (N=2, 3, 4, etc.). In an embodiment, applying a load to the solar cell can include applying an electrical load to the solar cell, where the electrical load can be configured to adjust electrical values applied to the solar cell. In an embodiment, applying a load can include applying a load based on a received voltage from first or a second location.

In an embodiment, applying a load to the solar cell can include applying a signal to the solar cell. For example, in various embodiments, applying a signal to the solar cell can include exposing the solar cell to light (e.g., such as performed in photo-luminescence testing), applying a current to locations (e.g., contact pads) of the solar cell (e.g., such as performed in electro-luminescence testing), or applying a laser to the solar cell (e.g., such as performed in laser-beam induced current testing), among other examples.

At 263, a voltage potential between the first and second locations can be reduced. In an embodiment, a feedback circuit, e.g., one that includes a differential amplifier, can be used to output a voltage difference based on a first and second voltage received by the feedback circuit from the first and second locations, respectively. In an embodiment, the voltage difference can be an absolute value (e.g. magnitude) of the difference (e.g. subtraction) of the first and second voltages. In an example such as in Current-Voltage (IV) Testing, the voltage difference can be supplied to a feedback element e.g. a variable resistor. The feedback element can also receive a first current. The feedback element can output a second current. In an embodiment, the feedback element can adjust the value of the second current based on the supplied voltage difference and first current. In an embodiment, the second current can be supplied into the first or second location, where supplying the second current into the first or second location can adjust a total voltage of the solar cell.

At 264, a voltage probe can be configured to receive and/or measure a voltage at a first or second location of the solar cell. In an embodiment, a first voltage probe can be configured to receive a first voltage at a first location of the solar cell. In one embodiment, a second voltage probe can be configured to receive a second voltage at a second location of the solar cell. The first or second location can be a positive or a negative contact location. The first or second location can also be a contact pad. In an embodiment, the first or second location can be any type of location which can be probed, measured, or receive an electrical signal, including a contact finger or metal contact region. In an embodiment, the first and second location can have the same polarity.

In an embodiment, the applied load from step 262 can be changed or varied after performing steps 263 and 264 and the steps 262-264 can be repeated one or more times.

In various embodiments, the method of FIG. 6 can include additional (or fewer) blocks than illustrated. For example, the method of FIG. 6 can further include receiving a N^{th} voltage at a N^{th} positive contact location of a solar cell, where the N^{th} voltage probe can be placed on an N^{th} positive contact location. In an embodiment, the feedback circuit can reduce the voltage potential between the first and N^{th} positive contact locations, where the feedback circuit can be coupled to the first and N^{th} voltage probes. In an embodiment, the feedback circuit can reduce the voltage potential between a first, second and N^{th} positive contact locations of the solar cell.

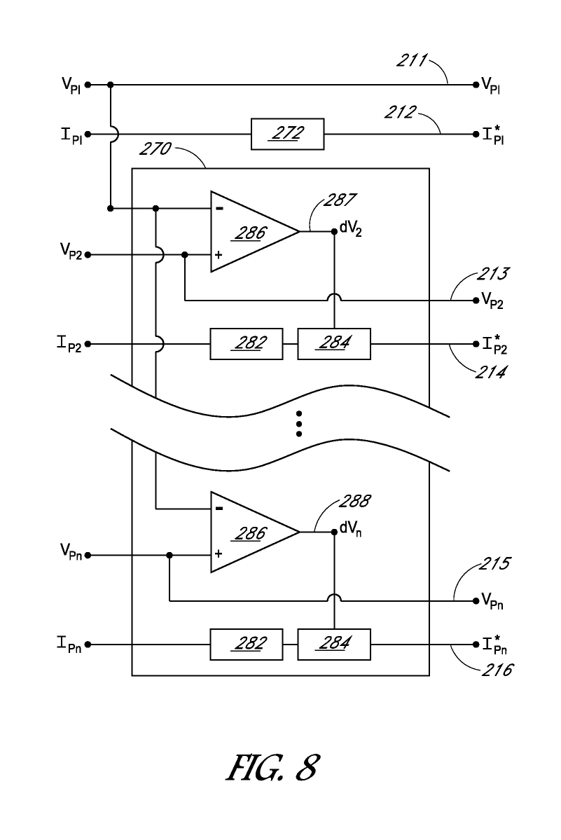

With reference to FIG. 7, portions of an example solar cell testing apparatus are shown, according to some embodiments. As shown, a first, second and up to an N^{th} voltage probes 211, 213, 215 can be coupled to a first, second and up to an N^{th} positive contact locations 201, 202, 203, respectively. As shown, first, second and up to an N^{th} current probe 212, 214, 216 can be coupled to a first, second and up to an N^{th} positive contact location 201, 202, 203, respectively.

In one embodiment, a feedback circuit 270 can be used to reduce the voltage potential among the first, second and N^{th} positive contact locations 201, 202, 203. In an embodiment, the feedback circuit 270 can be configured to receive a first, second and up to an N^{th} voltage V_{P1}, V_{P2}, V_{Pn} and/or a second and up to an N^{th} current I_{P2}, I_{Pn} from a first, second and up to an N^{th} location (e.g., a contact pad). In an embodiment, a first current I_{P1} can be coupled to a control device 272, such as a resistor. In an embodiment the control device can be configured to output a specific current I*_{P1}. In an example, the current can be a reference current for the feedback circuit. In an embodiment, the control device 272 need not be used. In an embodiment, the feedback circuit 270 can be configured to supply a second and up to an N^{th} current I*_{P2}, I*_{Pn}, where the second and up to an N^{th} currents I*_{P2}, I*_{Pn} can be output signals from the feedback circuit 270. The portion of the solar cell testing apparatus can include a first, second and up to an N^{th} current probe 212, 214, 216 placed on a first, second and up to an N^{th} positive contact location 201, 202, 203 respectively. In an embodiment, the first, second, and N^{th} voltages V_{P1}, V_{P2}, V_{Pn}, can have a positive polarity. In an embodiment, the first, second, and N^{th} currents I*_{P1}, P_{P2}, I*_{Pn} can have a positive polarity. In an embodiment, the first, second and N^{th} locations 201, 202, 203 can be of the same polarity. N can represent any number of probes and corresponding locations of the solar cell 200 (e.g., N=2, 3, 4, 5, etc.).

As shown in FIG. 7, a first, second and up to a M^{th} voltage probe 217, 219, 221 of opposite polarity to the first, second and N^{th} voltage probe 211, 213, 215 can be coupled to a first, second and up to a M^{th} negative contact location 204, 205, 206 respectively. The portion of the solar cell testing apparatus can also include a first, second and up to a M^{th} current probe 218, 220, 222 placed on a first, second and up to a M^{th} negative contact location 204, 205, 206 respectively. In an embodiment, the first, second, and M^{th} voltages V_{N1}, V_{N2}, V_{Nm} can have a negative polarity. Similarly, in an embodiment, the first, second, and M^{th} currents I_{N1}, I_{N2}, I_{Nm} can have a negative polarity. In an embodiment, the first, second and M^{th} negative contact locations 204, 205, 206 can be of the same polarity. M can represent any number of probes and corresponding locations of the solar cell 200 (e.g., M=2, 3, 4, 5, etc.). In an embodiment, M can have the same value as N.

Portions of the example solar cell testing apparatus of FIGS. 7 can be used in a variety of solar cell testing apparatus. For example, portions of the solar cell testing apparatus of FIG. 7 can be used with a Current-Voltage (IV) tester. In IV testing, a load (e.g., resistance value) is applied and current and voltage values are measured with corresponding load values. The current and voltage values can be plotted to generate the I-V curve of the solar cell, from which electrical parameters including the fill factor (FF) and the energy conversion efficiency (Eff) can be determined In an example, a feedback circuit can be used to reduce the voltage difference at the different contact locations 201, 202, 203, which can improve the accuracy of the voltage measurements in IV testing.

The feedback circuit 270 can also output a residual error, which can indicate an issue of a solar cell testing apparatus. In an embodiment, the feedback circuit 270 is configured to adjust the voltage between differences in the voltage values at the first, second and N^{th} positive contact locations. In an example, when the voltage differences among positive contact locations 201, 202, 203 of the same polarity are greater than a reference range, the testing apparatus of FIG. 7 can adjust the voltages and bring them within the reference range.

A benefit of using the feedback circuit 270 can include extending the working life/period of a solar cell testing apparatus. Also, the testing apparatus of FIG. 7 can allow for the determination of metal contacting issues of the solar cell such as defects caused by process excursions. In an embodiment, a reference solar cell can be used to distinguish between issues of the solar cell testing apparatus to solar cell defects (e.g. metal contact issues). In some embodiments, a reference solar cell can be used for calibration of the solar cell testing apparatus.

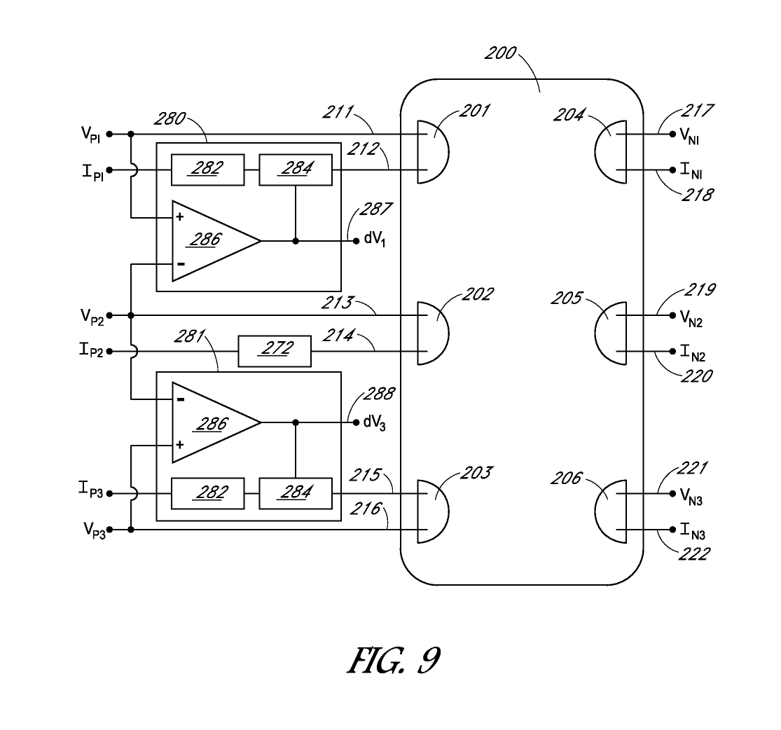

FIG. 8 illustrates an example feedback circuit, according to some embodiments. The feedback circuit 270 can include inputs to voltage probes 211, 213, 215 and current probes 214, 216. The feedback circuit 270 can be configured to receive a first, second and up to an N^{th} voltage V_{P1}, V_{P2}, V_{Pn} respectively. The feedback circuit 270 can be configured to receive a second and up to an N^{th} current I_{P2}, I_{Pn}. In an embodiment, the first voltage V_{P1} can be a reference voltage for the feedback circuit 270. In an embodiment, a first current I_{P1} can be applied to control device 272, such as a resistor. In an embodiment the control device 272 can be configured to output a specific current I*_{P1}. In an embodiment, the control device 272 need not be used. In an embodiment, the current I*_{P1} can be a reference current for the feedback circuit 270.

In an embodiment, a differential amplifier 286 can be configured to amplify a voltage difference between the first and second input voltage V_{P1}, V_{P2}, and the first and N^{th} input voltage V_{P1}, V_{Pn}. In an embodiment, the differential amplifier 286 can be configured to convert the voltage differences between the first and second input voltage V_{P1}, V_{P2}, and the first and N^{th} input voltage V_{P1}, V_{Pn} to amplified voltage signals dV₂, dVₙ. In an embodiment, the amplified voltage signals dV₂, dVₙ can be supplied to a feedback element 284 to increase or decrease a resistance value of the feedback element 284. Subsequently, an output current I*_{P2}, r_{Pn} of the feedback circuit 270 can be increased or decreased due to the resistance value at the feedback element 284. In an embodiment, the increase or decrease of the output current I*_{P2}, I*_{Pn} can allow the input voltages V_{P2}, V_{Pn} to approach the value of the reference voltage V_{P1}. Thus, the feedback circuit 270 can be used to reduce the voltage potential between a first, second and N^{th} locations of a solar cell, where the currents I*_{P1}, I*_{P2}, I*_{Pn} can be coupled to the first, second and N^{th} locations. In an embodiment, the amplified voltage signals dV₂, dVₙ can act on the feedback element 284 to supply a current to the solar cell and reduce the voltage potential between a first, second and N^{th} locations of a solar cell. In an embodiment, a contact probe 287, 288 can be used to measure the amplified voltage signal dV₂, dVₙ. In an embodiment, the feedback circuit 270 can also include adjustable device 282, such as an adjustable resistor. In an embodiment, the adjustable device 282 and feedback element 284 can be resistors or combinations of resistors. Also, N can represent any number of probes and corresponding locations of the solar cell 200 (e.g., N=2, 3, 4, 5, etc.).

With reference to FIG. 9, portions of an example solar cell testing apparatus are shown, according to some embodiments. As shown, a first, a second and a third voltage probe 211, 213 215 can be coupled to a first, second and third location 201, 202, 203, respectively. The illustrated portion of the solar cell testing apparatus can also include a first, a second and third current probe 212, 214, 216 placed on the first, second and third location 201, 202, 203.

In the illustrated embodiment, the solar cell testing apparatus can also include multiple feedback circuits (e.g., a first and second feedback circuit 280, 281). The first feedback circuit 280 can be configured to receive a first voltage V_{P1} and second voltage V_{P2}, respectively. The first feedback circuit can be configured to receive a first current I_{P1}. The second feedback circuit 281 can be configured to receive a second voltage V_{P2} and third voltage V_{P3}, respectively. The second feedback circuit can be configured to receive a third current I_{P3}.

In an embodiment, the first feedback circuit 280 can be configured to reduce the voltage potential between the second location 202 and the first location 201. In an embodiment, the second feedback circuit 281 can be configured to reduce the voltage potential between the second location 202 and the third location 203. In an embodiment, a first and a second feedback circuit 280, 281 can be configured to reduce the voltage potential among the first, second and third locations 201, 202, 203.

In an embodiment, the feedback circuits 280, 281 can include differential amplifiers 286. In an embodiment, the differential amplifier 286 of 280 can be configured to amplify a voltage difference between the first and second locations 201, 202, where the voltage difference can form an amplified voltage signal d_{V1}. In an embodiment, the differential amplifier 286 of 281 can be configured to amplify a voltage difference between the second and third locations 202, 203, where the voltage difference can form an amplified voltage signal dV₃. In an embodiment, the amplified voltage signals dV₁, dV₃ can be supplied to a feedback element 284, where the amplified voltage signals dV₁, dV₃ reduce the voltage potential between the first, second and third locations 201, 202, 203. In an embodiment, the amplified voltage signals dV₁, dV₃ can be supplied to a feedback element 284 to reduce the resistance of the feedback element. In an embodiment, a contact probes 287, 288 can be used to measure the amplified voltage signals dV₁, dV₃. In an embodiment, the solar cell testing apparatus can be an electro-luminescence tester, photo-luminescence tester, hot spot tester, Current-Voltage (IV) tester, or a laser-beam induced current tester.

The solar cell testing apparatus can also include a first, a second and third voltage probe 217, 219, 221 of opposite polarity to the first, second and third voltage probe 211, 213, 215. The solar cell testing apparatus can include a first, a second and third current probe 218, 220, 222. In an embodiment, the voltage and current probes can be placed on a fourth, fifth and sixth location 204, 205, 206 respectively. In an embodiment, the first, second, and third voltages V_{N1}, V_{N2}, V_{N3} can have a negative polarity. In an embodiment, the first, second third currents I_{N1}, I_{N2}, I_{N3} can have a negative polarity. In an embodiment, the first, second and third locations 204, 205, 206 can be of the same polarity.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A solar cell testing apparatus, comprising:
a first electrical probe configured to receive a first voltage at a first location of a solar cell;
a second electrical probe configured to receive a second voltage at a second location of the solar cell, wherein the second location is of a same polarity as the first location.

2. The solar cell testing apparatus of claim 1, wherein the first and second locations are first and second contact pads, respectively.

3. The solar cell testing apparatus of claim 1, further comprising a switch configured to switch between the first or second electrical probe.

4. The solar cell testing apparatus of claim 3, wherein the switch comprises an electrical switch.

5. The solar cell testing apparatus of claim 4, wherein the electrical switch is programmed to cycle periodically, allowing for the measurement of voltage values at different locations periodically.

6. The solar cell testing apparatus of claim 1, further comprising:
a third electrical probe configured to receive a third voltage at a third location of the solar cell, wherein the third location is of the same polarity as the first and second location.

7. The solar cell testing apparatus of claim 1, wherein the solar cell testing apparatus is an electro-luminescence tester, photo-luminescence tester, hot spot tester, current-voltage (IV) tester, or a laser-beam induced current tester.

8. A solar cell testing apparatus, comprising:
a first electrical probe configured to receive a first voltage at a first location of a solar cell;
a second electrical probe configured to receive a second voltage at a second location of the solar cell, wherein the second location is of a same polarity as the first location; and
a first feedback circuit coupled to the first and second electrical probes, wherein the first feedback circuit is configured to reduce a voltage potential between the first and second locations.

9. The solar cell testing apparatus of claim 8, wherein the first feedback circuit comprises:
a differential amplifier configured to convert a voltage difference between the first and second voltages to an amplified voltage signal; and
a feedback element configured to receive the amplified voltage signal, and supply a current to the solar cell that reduces the voltage potential between the first and second locations.

10. The solar cell testing apparatus of claim 8, further comprising:
a third electrical probe configured to receive a third voltage at a third location of the solar cell, wherein the third location is of the same polarity as the first and second location; and
a second feedback circuit coupled to the first and third electrical probes, wherein the second feedback circuit is configured to reduce a voltage potential between the first and third locations.

11. The solar cell testing apparatus of claim 8, wherein the solar cell testing apparatus is an electro-luminescence tester, photo-luminescence tester, hot spot tester, current-voltage (IV) tester, or a laser-beam induced current tester.

12. A method for testing a solar cell, the method comprising:
applying a load to a solar cell;
a first feedback circuit reducing a voltage potential, dependent on the load, between a first and second location of the solar cell; and
a first voltage probe receiving a first voltage at a first location of the solar cell.

13. The method of claim 12, further comprising:
a second voltage probe receiving a second voltage at a second location of the solar cell.

14. The method of claim 13, wherein the second voltage is received simultaneously with the first voltage.

15. The method of claim 13, wherein the second voltage is received 1-100 micro-seconds after the first voltage.

16. The method of claim 13, wherein reducing the voltage potential comprises:
converting a voltage difference between the first and second voltages to an amplified voltage signal; and
adjusting a signal of the feedback circuit based on the amplified voltage signal.

17. The method of claim 16, wherein the adjusting the signal comprises adjusting an output current of the feedback circuit based on the amplified voltage signal.

18. The method of claim 17, further comprising:
supplying the output current to a second location of the solar cell, wherein supplying the output current to the second location results in an adjusted total voltage of the solar cell.

19. The method of claim 12, further comprising determining a residual error of a voltage difference between the first and second voltages.

20. The method of claim 12, wherein applying a load comprises applying an electrical load, a resistive load, exposing the solar cell to light, applying a current or applying a laser to the solar cell.
